(19) United States
(12) Patent Application Publication
(10) Pub. No.: US 2025/0230311 A1
(43) Pub. Date: Jul. 17, 2025

(54) SILICONE-ACRYLIC BINDER FOR THERMAL INSULATION COATINGS TO PROVIDE RESISTANCE TO CORROSION UNDER INSULATION

(71) Applicants: Dow Global Technologies LLC, Midland, MI (US); Dow Silicones Corporation, Midland, MI (US); Rohm and Haas Company, Collegeville, PA (US)

(72) Inventors: Jenafer Duley, Midland, MI (US); Raghida Bou Zerdan, Midland, MI (US); Chris Simon, Midland, MI (US); Bienvenu Ndaruhutse, Midland, MI (US); Isabel Meza, Midland, MI (US); Erin Vogel, Midland, MI (US); Matthew Padaon, Richmond, VA (US); Eric Greyson, Blue Bell, PA (US); George Daisey, Elmer, NJ (US)

(21) Appl. No.: 19/096,969

(22) Filed: Apr. 1, 2025

Related U.S. Application Data
(63) Continuation-in-part of application No. PCT/US2024/043029, filed on Aug. 20, 2024.
(60) Provisional application No. 63/586,425, filed on Sep. 29, 2023.

(51) Int. Cl. C08L 33/04; C08K 3/22; C08K 3/28; C09D 5/02; C09D 5/08; C09D 7/20; C09D 7/61; C09D 7/80; C09D 133/04

(52) U.S. Cl. CPC C08L 33/04; C08K 3/28; C09D 5/024; C09D 5/084; C09D 7/20; C09D 7/61; C09D 7/80; C09D 133/04; C08K 2003/2241

(57) ABSTRACT

A silicone-acrylic binder is made from a combination of I) a first aqueous emulsion containing a soft acrylic polymer, II) a second aqueous emulsion containing a silicone resin. The silicone-acrylic binder can be used to prepare a thermal insulation coating composition that may be applied on a metal (e.g., steel) substrate or primed substrate. A thermal insulation coating prepared by drying the thermal insulation coating composition provides the metal or primed substrate with resistance to corrosion under insulation.

### CROSS REFERENCE TO RELATED APPLICATIONS

This application is a continuation in part of PCT Application No. PCT/US24/043029 filed on 20 Aug. 2024, currently pending, and which is hereby incorporated by reference.

### FIELD

This invention relates to a silicone-acrylic binder, and a thermal insulation coating composition, and methods for preparation thereof. More particularly, the binder and the thermal insulation coating composition comprises a soft acrylic polymer and a silicone resin. The composition can be applied to a metal surface or to a primed substrate and provides a thermal insulation coating with good protection against corrosion under insulation.

### INTRODUCTION

Insulation is used to prevent heat transfer from inside an asset (operation or apparatus such as a tank, pipe, vessel, furnace, valve, boiler, etc.) to the outside environment to improve process reliability and provide personnel protection. Mechanical (or physical or bulk) insulation solutions (such as fiberglass, foam wrap, etc., wrapped with metal shrouding, etc.) can be difficult to install on complex geometries, and may act as a sponge if/when exposed to water, exacerbating corrosion under insulation. This can lead to equipment failure and safety concerns.

Physical insulation is bulky and upon disposal after its useful lifetime and ends up in landfills. Liquid applied organic insulation typically requires long application time and has a poor exterior durability and/or lifetime, resulting in a higher amount of material usage over a given period to protect an asset. Physical insulation often requires metal shrouding with sharp edges and does not enable ease of early failure detection in the event of corrosion under insulation.

While incumbent liquid-delivered insulation products provide thermal insulation, they often require high maintenance costs and downtime for installation and repair. The spray applied solutions are typically applied in 20-50 mil thick coats and require several coats (up to or exceeding 10) to achieve adequate insulation, each of which require a long dry time. In addition, organic-based liquid applied thermal insulation coatings have innate concerns with exterior and/or long-term durability. Corrosion under insulation remains a challenge for both mechanical and liquid insulation solutions.

CN102585698A discloses an aqueous based industrial heat insulation coating useful in thermal insulation cover of heat transmitting pipe. The coating includes an aqueous based organic silicon resin, filler, and auxiliary materials.

### SUMMARY

A silicone-acrylic binder is useful to prepare a thermal insulation coating composition. The binder comprises: A) an acrylic polymer with Young's modulus≤50 psi, and B) a silicone resin. The thermal insulation coating composition comprises A) the acrylic polymer with Young's modulus≤50 psi, B) the silicone resin, an insulative filler, a metal oxide, and a flash rust inhibitor. Methods for the preparation and use of the binder and the thermal insulation coating composition are also provided.

### DETAILED DESCRIPTION

The binder introduced above may be prepared by a method comprising: i) homogenizing starting materials comprising I) a first aqueous emulsion comprising A) the acrylic polymer having Young's modulus≤50 psi and II) a second aqueous comprising B) the silicone resin. Step i) may be performed by any convenient means using any convenient equipment. Step i) may comprise combining (e.g., by simple mixing) starting materials comprising I) and II). Step i) may further comprise homogenizing via applying shear to starting materials comprising I) and II), thereby preparing an intermediate. In addition to, or instead of preparing the intermediate, the method may further comprise adding an additional starting material selected from the group consisting of C) an antifoam, D) a coalescing solvent, E) a pH modifier, and a combination of two or more thereof. The starting materials used to prepare the binder are described in detail as follows.

### Aqueous Acrylic Emulsion

Starting material I) is a first aqueous emulsion, which comprises starting material A) the acrylic polymer. The first aqueous emulsion further comprises water and a surfactant. The acrylic polymer has a Young's modulus≤50 psi. Alternatively, the acrylic polymer may have a Young's modulus up to 45 psi, alternatively up to 40 psi, alternatively up to 35 psi, alternatively up to 30 psi; while at the same time the acrylic polymer may have a Young's modulus of at least 5 psi, alternatively at least 6 psi, alternatively at least 17 psi, alternatively at least 20 psi, and alternatively at least 30 psi. Alternatively, the acrylic polymer may have a Young's modulus of 6 to ≤50 psi, alternatively 6 to 40 psi, and alternatively 20 to 40 psi.

The first aqueous emulsion may have a particle size, Dv50, of 200 nm to 400 nm, measured according to the test method for Particle Size Measurements described below. Alternatively, the first aqueous emulsion may have a Dv50 of at least 200 nm, alternatively at least 225 nm, alternatively at least 250 nm, alternatively at least 275 nm, alternatively at least 300 nm; while at the same time the first aqueous emulsion may have a Dv50 up to 400 nm, alternatively up to 375 nm, alternatively up to 350 nm, alternatively up to 325 nm, and alternatively up to 300 nm.

The first aqueous emulsion may comprise 54% to <56% of the acrylic polymer, 44% to <46% water, 0.1% to 0.3% diphenyl ketone, and 0 to <0.2% aqua ammonia. The first aqueous emulsion is commercially available. Suitable examples include RHOPLEX™ EC-3814 Emulsion Polymer (in which the acrylic polymer has a modulus of 17 psi); RHOPLEX™ 4400 (in which the acrylic polymer has a modulus of 6 psi); RHOPLEX™ EC-1791 Emulsion Polymer (in which the acrylic polymer has a modulus of 20 psi and a Dv50 with an average value of 350 nm); RHOPLEX™ EC-1791QS (in which the acrylic polymer has a modulus of 20 and a Dv50 with an average value of 350 nm); and RHOPLEX™ 2019RX Water-borne Binder (in which the acrylic polymer has a modulus of 40 psi and a Dv50 with an average value of 250 nm), all of which are commercially available from The Dow Chemical Company of Midland, Michigan USA.

Some examples of ethylenically unsaturated monomers that can be used to prepare the acrylic polymer described above include alkyl methacrylates having 1-12 carbon atoms such as methyl methacrylate, ethyl methacrylate, butyl methacrylate, hexyl methacrylate, 2-ethylhexyl methacrylate, nonyl methacrylate, lauryl methacrylate, cyclohexyl methacrylate, isodecyl methacrylate, propyl methacrylate, phenyl methacrylate, and isobornyl methacrylate; alkyl acrylates having 1-12 carbon atoms in the alkyl group such as methyl acrylate, ethyl acrylate, propyl acrylate, isopropyl acrylate, butyl acrylate, isobutyl acrylate, hexyl acrylate, 2-ethylhexyl acrylate, nonyl acrylate, lauryl acrylate, cyclohexyl acrylate, isodecyl acrylate, phenyl acrylate, and isobornyl acrylate; styrene, alkyl substituted styrene such as α-methyl styrene, t-butyl styrene, and vinyl toluene.

Alternatively, the acrylic polymer may comprise copolymerized ethylenically unsaturated carboxylic acid monomers. When such acid monomers are in their deprotonated form, as at a pH below the pKa of the acid monomers themselves, they can be referred to as anionic monomers. Such monomers may include, for example, an acid-functional group chosen from a phosphorus acid group, a sulfur acid group, salts thereof, and combinations thereof. The phosphorus acid-functional group may be a (di)hydrogen phosphate group, phosphonate group, phosphinate group, alkali metal salt thereof, other salt thereof, or a combination thereof. Suitable phosphorus acid group containing monomers may include, for example, (di)hydrogen phosphate esters of an alcohol containing a polymerizable vinyl or olefinic group, such as phosphates of hydroxyalkyl(meth)acrylates including hydroxyethyl (meth)acrylate. Other suitable such monomers may include, for example, phosphonate functional monomers, like vinyl phosphonic acid. Alternatively, the phosphorus acid monomers may include phosphoethyl (meth)acrylate.

### Aqueous Silicone Resin Emulsion

Starting material II) is a second aqueous emulsion. The second aqueous emulsion comprises B) the silicone resin. The second aqueous emulsion further comprises a surfactant and water. The silicone resin may comprise monofunctional units (“M” units) of formula R^{M}₃SiO_{1/2} and tetrafunctional units (“Q” units) of formula SiO_{4/2}, where each R^{M} is an independently selected monovalent hydrocarbon group. Suitable monovalent hydrocarbon groups for R^{M} may have 1 to 20 carbon atoms, alternatively 1 to 12 carbon atoms, alternatively 1 to 8 carbon atoms, alternatively 1 to 4 carbon atoms, and alternatively 1 to 2 carbon atoms. Alternatively, the hydrocarbon groups for R^{M} may be selected from the group consisting of alkyl groups, alkenyl groups, and aryl groups; alternatively alkyl and aryl; alternatively alkyl and alkenyl; and alternatively alkyl. Suitable alkyl groups may have 1 to 18 carbon atoms, alternatively 1 to 12 carbon atoms, and alternatively 1 to 6 carbon atoms. “Alkyl” means a cyclic, branched, or unbranched, saturated monovalent hydrocarbon group. Alkyl is exemplified by, but not limited to, methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, heptyl, octyl, nonyl, and decyl, and branched alkyl groups of 6 or more carbon atoms; and cyclic alkyl groups such as cyclopentyl and cyclohexyl. “Alkenyl” means a monovalent hydrocarbon group having one or more carbon-carbon double bonds. Alkenyl groups may be linear, branched or cyclic. Suitable alkenyl groups are exemplified by vinyl; allyl; propenyl (e.g., isopropenyl, and/or n-propenyl); and butenyl, pentenyl, hexenyl, and heptenyl, (also including branched isomers of 4 to 7 carbon atoms); and cyclohexenyl. “Aryl” means a cyclic, fully unsaturated, hydrocarbon group. Aryl is exemplified by, but not limited to, cyclopentadienyl, phenyl, anthracenyl, and naphthyl. Monocyclic aryl groups may have 5 to 9 carbon atoms, alternatively 6 to 7 carbon atoms, and alternatively 5 to 6 carbon atoms. Polycyclic aryl groups may have 10 to 17 carbon atoms, alternatively 10 to 14 carbon atoms, and alternatively 12 to 14 carbon atoms. Alternatively, each R^{M} may be independently selected from methyl and phenyl. Alternatively, each R^{M} may be alkyl. Alternatively, each R^{M} may be methyl.

Alternatively, in the silicone resin, each R^{M} may be independently selected from the group consisting of alkyl, alkenyl, and aryl. Alternatively, each R^{M} may be selected from methyl, vinyl and phenyl. Alternatively, at least one-third, alternatively at least two thirds of the R^{M} groups are methyl groups. Alternatively, the monofunctional units may be exemplified by (Me₃SiO_{1/2}), (Me₂PhSiO_{1/2}), and (Me₂ViSiO_{1/2}). The silicone resin is soluble in organic solvents exemplified by liquid hydrocarbons, such as benzene, toluene, xylene, and heptane, or in liquid organosilicon compounds such as low viscosity linear and cyclic polydiorganosiloxanes.

When prepared, the silicone resin comprises the monofunctional and tetrafunctional units described above, and the polyorganosiloxane further comprises units with silanol (silicon bonded hydroxyl) groups and may comprise neopentamer of formula Si(OSiR^{M}₃)₄, where R^{M} is as described above. Si²⁹ Nuclear Magnetic Resonance (NMR) spectroscopy, as described in U.S. Pat. No. 9,593,209 at col. 32, Reference Example 2, may be used to measure molar ratio of M and Q units, where said ratio is expressed as

{M(resin)+(M(neopentamer)}/{Q(resin)+Q(neopentamer)} and represents the molar ratio of the total number of triorganosiloxy groups (monofunctional units) of the resinous and neopentamer portions of the silicone resin to the total number of silicate groups (Q units) in the resinous and neopentamer portions.

The number average molecular weight, Mn, of the silicone resin depends on various factors including the types of hydrocarbyl groups represented by R^{M} that are present. The Mn of the silicone resin refers to the number average molecular weight measured using GPC according to the procedure in U.S. Pat. No. 9,593,209 at col. 31, Reference Example 1, when the peak representing the neopentamer is excluded from the measurement. The Mn of the silicone resin may be greater than 2,000 g/mol, alternatively 2,500 g/mol to 8,000 g/mol. Alternatively, Mn of the silicone resin may be 2,900 g/mol to 5,000 g/mol.

The silicone resin can be prepared by any suitable method, such as cohydrolysis of the corresponding silanes or by silica hydrosol capping methods. The silicone resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having monofunctional units and tetrafunctional units.

The intermediates used to prepare the silicone resin may be triorganosilanes and silanes with four hydrolyzable substituents or alkali metal silicates. The triorganosilanes may have formula R^{M}₃SiX¹, where R^{M} is as described above and X¹ represents a hydroxyl group or other hydrolyzable substituent, such as alkoxy. Silanes with four hydrolyzable substituents may have formula SiX²₄, where each X² is halogen, alkoxy or hydroxyl. Suitable alkali metal silicates include sodium silicate.

The silicone resin prepared as described above typically contains silicon bonded hydroxyl groups, i.e., of formulae, HOSi_{3/2} and/or HOR^{M}₂SiO_{1/2}. The silicone resin may comprise 2% to 5% of silicon bonded hydroxyl groups. The concentration of silicon bonded hydroxyl groups present in the silicone resin may be determined using Fourier Transform-Infra Red (FTIR) spectroscopy according to ASTM Standard E-168-16.

Alternatively, the silicone resin may comprise unit formula (R-1):

(R^{M}₃SiO_{1/2})ₓ(SiO_{4/2})_{y}X¹₂, where R^{M} and X¹ are as described above, and subscripts x, y and z have average values such that 4>x≥0, y>1, z>0. A quantity (x+y+z) is sufficient to give the silicone resin a weight average molecular weight (Mw) of 2,000 g/mol to 15,000 g/mole, alternatively 8,000 to 10,000, and alternatively 9,000 to 9,500. Alternatively, each X¹ may be —OH and subscript z may be 0 to a value sufficient to provide the resin with up to 5% —OH groups, alternatively up to 2 weight % —OH groups. Suitable silicone resins are known in the art and may be made by known methods, as described above. Alternatively, suitable silicone resins are disclosed in U.S. Pat. No. 7,807,744 to Barnes, et al., which is hereby incorporated by reference.

The second aqueous emulsion further comprises a surfactant. The choice of surfactant is not specifically restricted and may be selected from the group consisting of anionic surfactants, cationic surfactants, amphoteric surfactants, nonionic surfactants, and combinations of two or more thereof.

The anionic surfactants include (i) sulfonic acids and their salt derivatives, including alkyl or aralkyl (e.g., alkyl naphthalene or alkyl diphenyl ether) sulfonic acids, and their salts, having at least 6 carbon atoms in the alkyl substituent, such as dodecyl benzene sulfonic acid, and its sodium salt or its amine salt; (ii) alkyl sulfates having at least 6 carbon atoms in the alkyl substituent, such as sodium lauryl sulfate; (iii) the sulfate esters of polyoxyethylene monoalkyl ethers; (iv) long chain carboxylic acid surfactants, such as lauric acid, steric acid, oleic acid, and their alkali metal and amine salts. Some other examples of anionic surfactants are alkali metal sulfosuccinates; sulfonated glyceryl esters of fatty acids such as sulfonated monoglycerides of coconut oil acids; salts of sulfonated monovalent alcohol esters such as sodium oleyl isothionate; amides of amino sulfonic acids such as the sodium salt of oleyl methyl tauride; sulfonated products of fatty acid nitriles such as palmitonitrile sulfonate; sulfonated aromatic hydrocarbons such as sodium alpha-naphthalene monosulfonate; condensation products of naphthalene sulfonic acids with formaldehyde; sodium octahydro anthracene sulfonate; alkali metal alkyl sulfates; ether sulfates having alkyl groups of eight or more carbon atoms such as sodium lauryl ether sulfate; and alkylaryl sulfonates having one or more alkyl groups of eight or more carbon atoms such as neutral salts of hexadecylbenzene sulfonic acid and C₂₀ alkylbenzene sulfonic acid.

Commercial anionic surfactants which can be used include the sodium salt of dodecyl benzene sulfonic acid sold under the trademark SIPONATE™ DS-10 by Alcolac Inc., Baltimore, Maryland; sodium salt of alkyl alkoxylate sulfate sold under the trademark DOWFAX™ AS-801 by The Dow Chemical Company of Midland, Michigan, USA; sodium n-hexadecyl diphenyloxide disulfonate sold under the trademark DOWFAX™ 8390 by The Dow Chemical Company, Midland, Michigan; the sodium salt of a secondary alkane sulfonate sold under the trademark HOSTAPUR™ SAS 60 by Clariant Corporation, Charlotte, North Carolina; N-acyl taurates such as sodium N-lauroyl methyl taurate sold under the trademark NIKKOL LMT™ by Nikko Chemicals Company, Ltd., Tokyo, Japan; and linear alkyl benzene sulfonic acids sold under the trademark BIO-SOFT™ S-100 by the Stepan Company, Northfield, Illinois. Other suitable surfactants include sodium alkyl sulfonate such as HOSTAPUR™ SAS-30, and triethanolamine dodecyl benzene sulfonate, such as BIO-SOFT™ N 300.

Cationic surfactants useful herein include compounds containing quaternary ammonium hydrophilic moieties in the molecule which are positively charged, such as quaternary ammonium salts represented by R⁸R⁹R¹⁰R¹¹N⁺X⁻ where R⁸ to R¹¹ are alkyl groups containing 1-30 carbon atoms, or alkyl groups derived from tallow, coconut oil, or soy; and X is a halogen, e.g., chlorine or bromine. Alternatively, the quaternary ammonium compounds may be alkyl trimethylammonium and dialkyldimethylammonium halides, or acetates, or hydroxides, having at least 8 carbon atoms in each alkyl substituent. Dialkyl dimethyl ammonium salts can be used and are represented by R¹²R¹³N⁺(CH₃)₂X⁻ where R¹² and R¹³ are alkyl groups containing 12-30 carbon atoms or alkyl groups derived from tallow, coconut oil, or soy; and X is a halogen as described above. Monoalkyl trimethyl ammonium salts can be used and are represented by R¹⁴N+(CH₃)₃X′⁻ where R¹⁴ is an alkyl group containing 12-30 carbon atoms or an alkyl group derived from tallow, coconut oil, or soy; and X′ is halogen, acetate, or hydroxide.

Representative quaternary ammonium halide salts are dodecyltrimethyl ammonium chloride/lauryltrimethyl ammonium chloride (LTAC), cetyltrimethyl ammonium chloride (CTAC), didodecyldimethyl ammonium bromide, dihexadecyldimethyl ammonium chloride, dihexadecyldimethyl ammonium bromide, dioctadecyldimethyl ammonium chloride, dieicosyldimethyl ammonium chloride, and didocosyldimethyl ammonium chloride. These quaternary ammonium salts are commercially available under trademarks such as ADOGEN™ and VARIQUAT™ from Evonik of Essen, Germany, and ARQUAD™ from Nouryon.

Other suitable cationic surfactants which can be used include fatty acid amines and amides and their salts and derivatives, such as aliphatic fatty amines and their derivatives. AMMONYX™ by the Stepan Company, Northfield, Illinois.

Some suitable nonionic surfactants which can be used include polyoxyethylene alkyl ethers (such as, lauryl, cetyl, stearyl or octyl), polyoxyethylene alkyl phenol ethers, alkylglycosides, polyoxyethylene fatty acid esters, sorbitan fatty acid esters, polyoxyethylene sorbitan fatty acid esters, polyoxyethylene sorbitan monooleates, polyoxyethylene alkyl esters, polyoxyethylene sorbitan alkyl esters, polyethylene glycol (such as polyethylene glycol having 23 ethylene-oxide units), polypropylene glycol, diethylene glycol, ethoxylated trimethylnonanols, tristyrylphenol ethers (TSP's), distyryl phenol ethers (DSP's), and polyoxyalkylene glycol modified polysiloxane surfactants.

Nonionic surfactants which are commercially available include compositions such as (i) 2,6,8-trimethyl-4-nonyloxy polyethylene oxyethanols (6EO) and (10EO) sold under the names TERGITOL™ TMN-6 and TERGITOL™ TMN-10; (ii) the C₁₁₋₁₅ secondary alkyl polyoxyethylene ethers (e.g., C₁₁₋₁₅ secondary alcohol ethoxylates 7EO, 9EO, and 15EO sold under the names TERGITOL™ 15-S-7, TERGITOL™ 15-S-9, and TERGITOL™ 15-S-15, which has HL value 15.4), other C₁₁₋₁₅ secondary alcohol ethoxylates sold under the tradenames ECOSURF™ EH-40 and TERGITOL™ 15-S-12, TERGITOL™ 15-S-30, and TERGITOL™ 15-S-40, by the Dow Chemical Company, of Midland, Michigan, USA; octylphenyl polyoxyethylene (40) ether sold under the name TRITON™ X-405 by the Dow Chemical Company; (iii) nonylphenyl polyoxyethylene (10) ether sold under the name MAKON™ 10 by the Stepan Company; (iv) ethoxylated alcohols sold under the name Trycol 5953 by Henkel Corp./Emery Group, of Cincinnati, Ohio, USA; (v) ethoxylated alcohols sold under the name BRIJ™ L23 (with HLB value of 16.9) and BRIJ™ L4 (with HLB value of 9.7) by Croda Inc. of Edison, New Jersey, USA, (vi) polyoxyethylene 23 lauryl ether (Laureth-23) sold commercially under the trademark BRIJ™ 23 by ICI Surfactants, Wilmington, Delaware; and RENEX™ 30, a polyoxyethylene ether alcohol sold by ICI Surfactants, Wilmington, Delaware, USA; (vii) alkyl-oxo alcohol polyglycol ethers such as GENAPOL™ UD 050 (with HLB value of 11.4), and GENAPOL™ UD110 (with HLB value of 14.4), (viii) alkyl polyethylene glycol ether based on C10-Guerbet alcohol and ethylene oxide such as LUTENSOL™ XP 79, and (ix) alkyl polyglycosides, such as those sold under the trade name Glucopon™ by BASF, and alkyl glucosides such as decyl glucoside, lauryl glucoside, and coco-glucoside, which are sold under the trade name EcoSense™ by The Dow Chemical Company of Midland, Michigan, USA. Other commercially available nonionic surfactants include TERGITOL™ 15-S-5, also from The Dow Chemical Company, which has an HLB value of 10.5; Lutensol XP 50 with an HLB value of 10, and Lutensol XP 140 with an HLB value of 16.

Suitable nonionic surfactants also include poly(oxyethylene)-poly(oxypropylene)-poly(oxyethylene) tri-block copolymers. Poly(oxyethylene)-poly(oxypropylene)-poly(oxyethylene) tri-block copolymers are also commonly known as Poloxamers. They are nonionic triblock copolymers composed of a central hydrophobic chain of polyoxypropylene (poly(propylene oxide)) flanked by two hydrophilic chains of polyoxyethylene (poly(ethylene oxide)). Poly(oxyethylene)-poly(oxypropylene)-poly(oxyethylene) tri-block copolymers are commercially available from BASF of Florham Park, New Jersey, USA, and are sold under the tradename PLURONIC™, such as PLURONIC™ L61, L62, L64, L81, P84.

The nonionic surfactant may also be a silicone polyether (SPE). The silicone polyether as a surfactant may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Alternatively, the SPE may have a resinous structure, such as a polyorganosilicate resin having polyether groups bonded to silicon atoms therein. Suitable SPE's include DOWSIL™ OFX-5329 Fluid from Dow Silicones Corporation of Midland, Michigan, USA. Alternatively, the nonionic surfactant may be selected from polyoxyalkylene-substituted silicones, silicone alkanolamides, silicone esters and silicone glycosides. Such silicone-based surfactants may be used to form such aqueous emulsions and are known in the art, and have been described, for example, in U.S. Pat. No. 4,122,029 to Gee et al., U.S. Pat. No. 5,387,417 to Rentsch, and U.S. Pat. No. 5,811,487 to Schulz et al. Other silicone polyether surfactants are known in the art and are also commercially available, e.g., DOWSIL™ 502W Additive and DOWSIL™ 67 Additive are commercially available from Dow Silicones Corporation of Midland, Michigan, USA.

Alternatively, the nonionic surfactant may comprise a polyvinyl alcohol compound. Polyvinyl alcohol compounds are known in the art and are disclosed, for example in U.S. Patent Application Publication 2007/0099007 at paragraphs and [0173]. Polyvinyl alcohol compounds may be made by saponification of polyvinylacetate, so up to 15% of polyvinylacetate may remain in the polyvinyl alcohol compound used herein. Alternatively, the polyvinyl alcohol compound may be 88% to 92% polyvinyl alcohol (with the balance being 12% to 8% polyvinylacetate). The polyvinyl alcohol compound may have a minimum viscosity of 5 cP at 4% aqueous solution at 20° C.

The second aqueous emulsion further comprises water. The water is not generally limited, and may be utilized neat (i.e., absent any carrier vehicles and/or solvents), and/or pure (i.e., free from, or substantially free from, minerals and/or other impurities). For example, the water may be processed or unprocessed prior to use in the methods and compositions described herein. Examples of processes that may be used for purifying the water include distilling, filtering, deionizing, and combinations of two or more thereof, such that the water may be deionized, distilled, and/or filtered. Alternatively, the water may be unprocessed (e.g. may be tap water, i.e., provided by a municipal water system or well water, used without further purification). Alternatively, the water may be purified before use herein.

Alternatively, starting material II) the second aqueous emulsion may comprise a phenyl silsesquioxane resin, an alkoxysilane, a hydroxy-terminated polydialkylsiloxane, an aminofunctional polysiloxane, a surfactant (as described above), and water (also as described above). The second aqueous emulsion may be prepared by a process comprising I) combining the phenylsilsesquioxane resin, the alkoxysilane, the hydroxy-terminated polydialkylsiloxane, a surfactant, and water to form a dispersion, II) shearing the dispersion to form an emulsion, and III) admixing an emulsion of an aminofunctional polysiloxane to the emulsion.

The phenyl silsesquioxane resin is an organopolysiloxane having at least one siloxy unit of the formula (PhSiO_{3/2}). The phenyl silsesquioxane resin further comprise have any combination of (R^{M}₃SiO_{1/2}), (R^{M}₂SiO_{2/2}), (R^{M}SiO_{3/2}) and (SiO_{4/2}) units, where R^{M} is as described above, (provided that the phenyl silsesquioxane resin has at least one siloxy unit of the formula (PhSiO_{3/2})). The phenyl silsesquioxane resin may have an average formula comprising at least 40 mole % of siloxy units having the unit formula (R^{M}₂SiO_{2/2})ₓ(PhSiO_{3/2})_{y}, where subscripts x and y each have a value of 0.05 to 0.95. As used herein, x and y represent the mole fraction of (R^{M}₂SiO_{2/2}) and (PhSiO_{3/2}) units, respectively (i.e., D and T-phenyl siloxy units) relative to each other present in the phenyl silsesquioxane resin. Thus, the mole fractions of (R^{M}₂SiO_{2/2}) and (PhSiO_{3/2}) siloxy units each can independently vary from 0.05 to 0.95. However, the combination of (R^{M}₂SiO_{2/2}) and (PhSiO_{3/2}) units present must total at least 40 mole %, alternatively 80 mole %, or alternatively 95 mole % of all siloxy units present in the phenyl silsesquioxane resin. Alternatively, in the unit formula for the phenyl silsesquioxane resin above, each R^{M} may have 1 to 8 carbon atoms.

Alternatively, in addition to (R^{M}₂SiO_{2/2}) and (PhSiO_{3/2}) units, the phenyl silsesquioxane resin may optionally further comprise one or more additional units such that the phenyl silsesquioxane resin comprises unit formula

(R^{M}₂SiO_{2/2})ₓ(PhSiO_{3/2})_{y}(R^{M1}₃SiO_{1/2})ₐ(R^{M2}₂SiO_{2/2})_{b}(R^{M3}SiO_{3/2})_{c}(SiO_{4/2})_{d}, where R^{M}, x and y are as described above; R^{M1}, R^{M2}, and R^{M3} are each independently selected from an alkyl group of 1 to 8 carbon atoms, an aryl group, an amino group, or a carbinol group, and subscripts a, b, c, and d represent mole fractions, each having a value of 0 to 0.6. In this unit formula a quantity (x+y+a+b+c+d)=1. The carbinol group may be any group containing at least one carbon-bonded hydroxy (COH) group, alternatively more than one COH group. Examples of carbinol groups include R⁴OH, where each R⁴ is an independently selected divalent hydrocarbon group such as an alkylene group selected from —(CH₂)_{z}—, where subscript z is 3 to 10; —CH₂CH(CH₃)—, —CH₂CH(CH₃)CH₂—, —CH₂CH₂CH(CH₂CH₃)CH₂CH₂CH₂— and —OCH(CH₃)CH₂)_{w}—, where subscript w has a value of 1 to 10. Examples of carbinol groups further include groups of formula R⁵OH, where R⁵ is an arylene group such as —(CH₂)ᵥC₆H₄— wherein subscript v has a value of 0 to 10, —(CH₂)ᵥC₆H₄(CH₂)ᵥ— wherein each subscript v independently has a value of 0 to 10. The aryl-containing carbinol groups typically have from 6 to 14 atoms. Alternatively, the aryl functional carbinol group may have more than one OH per molecule, such as 5-methylbenzene-1,3-diol. Any individual D, T or Q siloxane units of the phenyl silsesquioxane resins can also contain a hydroxy group and/or alkoxy group. The hydroxy groups in these siloxane resins typically result from the reaction of the hydrolyzable group on the siloxane unit with water. The alkoxy groups result from incomplete hydrolysis when alkoxysilane precursors are used or from exchange of alcohol with hydrolyzable groups. Typically, the weight percent of the total hydroxy groups present in the phenyl silsesquioxane resin is up to 40 wt %. The molecular weights of the phenyl silsesquioxane resins are not restricted, but typically Mn may be 500 g/mol to 10,000 g/mol, alternatively 500 g/mol to 200 g/mol. Examples of suitable phenylsilsesquioxane resin may comprise unit formula (Me₂SiO_{2/2})ₓ(PhSiO_{3/2})_{y}, where subscripts x and y each have a value of 0.05 to 0.95 and the quantity (x+y)>0.40.

The alkoxysilane may have formula R⁸ₐSi(OR⁹)₍₄₋ₐ₎, where each R⁸ is independently selected from the group consisting of an alkyl, or a haloalkyl, group of 1 to 30 carbon atoms and an aryl group, each R9 is an independently selected alkyl group of 1 to 6 carbon atoms, and subscript a is 1 or 2. Alternatively, each R⁸ and each R⁹ may be an alkyl group as described and exemplified above for R^{M}. Alternatively, R⁸ may be n-octyl and R⁹ may be ethyl or methyl. Suitable alkoxysilanes include trialkoxysilanes (where a=1) such as methyltriethoxysilane, methyltripropoxysilane, ethyltrimethoxysilane, ethyltributoxysilane, propyltrimethoxysilane, propyltriethoxysilane, isobutyltrimethoxysilane, isobutyltriethoxysilane, butyltriethoxysilane, hexyltrimethoxysilane, n-octyltriethoxysilane. Suitable dialkoxysilanes (where a=2) include dimethyldimethoxysilane, dimethyldiethoxysilane, diethyldimethoxysilane, diisobutyldimethoxysilane, phenyltrimethoxysilane, dibutyldiethoxysilane, and dihexyldimethoxysilane.

The hydroxy-terminated polydialkylsiloxane may have unit formula [R⁹₂Si(OH)O_{1/2}]₂(R⁹₂SiO_{2/2})ᵤ, where R⁹ is as described above, and subscript u is 1 to 500, alternatively 5 to 200, alternatively 10 to 100. Alternatively, the hydroxy-terminated polydialkylsiloxane may be a hydroxy-terminated polydimethylsiloxane.

When starting material II) the second aqueous emulsion comprises the phenylsilsesquioxane resin, the surfactant and water may be as described and exemplified above for the embodiment where II) the second aqueous emulsion comprises the MQ resin.

Alternatively, II) the second aqueous emulsion may comprise:
10% to 50%, alternatively 20% to 45%, alternatively 30% to 45%; of the phenyl silsesquioxane resin;
9% to 19%, alternatively 9% to 12%, and alternatively 11% to 19% of the alkoxysilane described above,
1% to 15%, alternatively 5% to 15%, and alternatively 10% to 15%, of the hydroxyl terminated polydialkylsiloxane,
1 to 2.4% of the amino-functional polyorganosiloxane,
0.8% to 2.0%, alternatively 0.9% to 2%, alternatively 0.8% to 1.1% of a non-ionic surfactant,
>0% to 10% of the surfactant (e.g., nonionic surfactant), alternatively 0.5% to 5%, and alternatively 1% to 5% of the surfactant, and
a balance to 100% of water.

Suitable aqueous emulsions of silicone resins are commercially available. For example, DOWSIL™ 87 Additive, DOWSIL™ 901H Additive, DOWSIL™ IE-6683 Water Repellent, and DOWSIL™ IE-6694 Water Repellent can be used as starting material II). Aqueous emulsions of silicone resins may be as disclosed in U.S. Pat. No. 8,354,480 to McAuliffe, et al. or U.S. Pat. No. 7,780,744 to Barnes, et al. both of which are hereby incorporated by reference. Without wishing to be bound by theory, it is thought that including the first aqueous emulsion and the second aqueous emulsion in the thermal insulation coating composition may enable thicker film application capable of drying under ambient conditions without mud cracking than a comparable composition that does not contain starting materials I) or II). Without wishing to be bound by theory, it is thought that the silicone resin may improve corrosion resistance and/or provide good weatherability, breathability and/or hydrophobicity to the thermal insulation coating.

Starting materials I) and II) may be used in the method for preparing the binder in amounts of 70 to 99.9 weight parts of starting material I) the first aqueous emulsion, and 0.1 to 30 weight parts of starting material II) the second aqueous emulsion.

One or more additional starting materials may optionally be used in the method to make the binder. The optional additional starting material may be selected from the group consisting of: C) an antifoam, D) a coalescing solvent, E) a pH modifier, and a combination of two or more thereof.

### C) Antifoam

Starting material C) is an antifoam. Without wishing to be bound by theory, it is thought that the antifoam may be added to the binder for the thermal insulation coating composition to during processing to prevent or minimize air entrapment. Suitable antifoams may comprise silica and optionally a polyorganosiloxane compound. Suitable antifoams are commercially available and include DOWSIL™ 107F Additive, DOWSIL™ 8590 Additive, DOWSIL™ 8603 Additive, and DOWSIL™ 8610 Additive, all of which are commercially available from The Dow Chemical Company of Midland, Michigan, USA. The amount of D) the antifoam may be 0 to an amount sufficient to provide 10 ppm of antifoam active (e.g., polyorganosiloxane and/or silica) to the binder, based on combined weights of starting materials I), II), and), and when present E) and/or F).
E) pH Modifier

Starting material E) is a pH modifier that may optionally be added, for example, when the pH of starting material I) is less than 8, alternatively less than 8.5. Without wishing to be bound by theory, it is thought that adding the pH modifier may assist in stabilizing an aerogel in the thermal insulation coating composition. Suitable pH modifiers are commercially available and included bases such as ammonia or ammonium hydroxide, NH₄OH. The amount of pH modifier may be 0 to an amount sufficient to adjust pH of a combination of starting material I), the binder, and/or the thermal insulation coating composition to have a pH≥8, alternatively >8.5, alternatively 8.5 to 9.

### Binder

The binder prepared as described above may comprise: 19 to 65 weight parts of A) the acrylic polymer, 0.007 to 25 weight parts of B) the silicone resin, 0 to 1 weight part of C) the antifoam, 0 to 5 weight parts of D) the coalescing solvent, and ≥0 weight parts of E) the pH modifier (alternatively 0 to 2 weight parts pH modifier), 33 to 75 weight parts of water, and ≥0 weight parts of a surfactant. One skilled in the art would recognize that water and surfactant may be introduced via the aqueous emulsions I) and II) used to prepare the binder. The binder has the form of an emulsion or dispersion.

Alternatively, the binder may comprise 42 to 57.5 weight parts of A) the acrylic polymer, 3 to 8.5 weight parts of B) the silicone resin, 0.25 to 0.35 weight part of C) the antifoam, 1 to 1.6 weight parts of D) the coalescing solvent, 1.2 to 2 weight parts of E) the pH modifier, 38 to 48.8 weight parts of J) water, and 2 to 3 weight parts of F) the surfactant.

### Method for Making Thermal Insulation Coating Composition

The binder described above may be used to make a thermal insulation coating composition. For example, the thermal insulation coating composition may be prepared by combining the binder, described above, with an additional starting material selected from the group consisting of F) a surfactant, G) an insulative filler, H) a metal oxide, I) a flash rust inhibitor, J) water, K) a rheology modifier, and a combination of two or more thereof. Alternatively, the starting materials described above may be used in a method to make a thermal insulation coating, whether or not the binder is made. For example, a method for making the thermal insulation coating composition may comprise:
1) homogenizing starting materials comprising:
   I) the first aqueous emulsion comprising A) the acrylic polymer, a first surfactant, and water;
   II) the second aqueous emulsion comprising B) the silicone resin, a second surfactant, and water;
optionally 2) during and/or after step 1), adding an additional starting material selected from the group consisting of C) the antifoam, D) the coalescing solvent, E) the pH modifier, F) an additional surfactant, G) an insulative filler, I) a metal oxide) and a combination of two or more thereof. The first surfactant and the second surfactant may be the same or different, and may be as described and exemplified above.

Alternatively, the method for making the thermal insulation coating composition may comprise:
1) practicing the method for making the binder described above,
optionally 2) adding F) an additional surfactant during and/or after step 1),
3) adding G) an insulative filler to the binder prepared in step 1) or step 2) and homogenizing to prepare a filled intermediate; and
4) adding, to the filled intermediate, a slurry comprising I) a metal oxide, and a solution or slurry comprising I) a flash rust inhibitor before, during, or after any one of steps 1) to 3), and homogenizing,
optionally 5) adding E) a pH modifier in step 1) when I) the first aqueous emulsion has pH<8;
6) adding C) an antifoam before, during and/or after adding the insulative filler in step 3). The method may optionally further comprise adding an additional starting material selected from the group consisting of C) an additional antifoam, D) a coalescing solvent, and a combination thereof. The method may optionally further comprise adding K) a rheology modifier after step 2). The method may further comprise adding additional J) water.

Alternatively, and more particularly, the method for making the thermal insulation coating composition introduced above may comprise:
optionally i) combining (e.g., by simple mixing) I) the first aqueous emulsion and II) the second aqueous emulsion;
   ii) homogenizing I) the first aqueous emulsion and II) the second aqueous emulsion, thereby preparing the homogeneous intermediate, and thereafter optionally iii) adding C) the antifoam,
   optionally iv) adjusting pH by adding E) the pH modifier; thereby forming a pre-mix,
v) mixing the pre-mix,
optionally vi) adding an additional C) antifoam to the pre-mix,
optionally vii) adding D) the coalescing solvent to the pre-mix,
viii) adding V) a slurry comprising I) the metal oxide to the pre-mix,
ix) adding I) the flash rust inhibitor (either neat or as a dispersion or solution of the flash rust inhibitor in water) to the pre-mix,
   optionally x) adding IV) a slurry or solution comprising F) an additional surfactant to the premix,
   optionally xi) adding D) the coalescing solvent to the pre-mix, if the coalescing solvent was not added in step vii),
xii) adding G) an insulative filler comprising a hydrophobic aerogel to the pre-mix and mixing until the insulative filler is wet and homogeneously dispersed in the pre-mix,
   optionally xiii) adding J) water,
   optionally xiv) adding K) a rheology modifier, and
   optionally xv) adding additional water. The starting materials I), II), A), B), C), D), and

E), used in the above method for making the thermal insulation coating composition are described in detail above. The additional starting materials used in making the thermal insulation coating composition are described in detail as follows.

### F) Surfactant

Starting material F) is a surfactant that may optionally be added in the thermal insulation coating composition in addition to any surfactants present in starting materials I) and II). The surfactant may be nonionic, cationic, anionic, or amphoteric, and is as described and exemplified above for II) the second aqueous emulsion. Alternatively, starting material F) may comprise a nonionic surfactant. Without wishing to be bound by theory, it is thought that adding a surfactant, such as a nonionic surfactant (in addition to any surfactant(s) present in the aqueous emulsions I) and II) described above) may facilitate dispersion of G) the insulative filler (e.g., hydrophobic aerogel) in the thermal insulative coating composition and/or improve corrosion prevention of a thermal insulation coating on a metal substrate. The surfactant may be added neat. Alternatively F) the surfactant may be dispersed in water and delivered as IV) a slurry or solution comprising water and F) the surfactant.

### G) Insulative Filler

Starting material G) is an insulative filler that may be used to reduce thermal conductivity, improve hydrophobicity, improve thick-film application, or a combination of forementioned, of the thermal insulation coating prepared from the thermal insulation coating composition. The insulative filler may comprise, alternatively may consist essentially of, alternatively may consist of a hydrophobic aerogel. The term “aerogel” is used to describe a synthetic, highly porous, ultralight-weight material derived from a gel, the liquid components of which have been replaced with a gas (e.g., air). In other words, an aerogel is a gel with the gas as dispersion medium. Historically, the most common method of preparation was by drying a wet sol-gel at temperatures above the critical temperature and at a pressure above the critical pressure. This kind of drying drives off the liquid contained in the gel, e.g., water, and results in a porous structure without damaging the solid matrix structure of the gel. Up to 99.98% of the volume of aerogels may consist of pores. Thus, e.g., up to 99.98 vol. %, such as 90 to 98.5 vol. % or about 97 vol. %, of an aerogel may be air. Aerogels are micro-or nanoporous open cell solids and dry materials. Typically they comprise a porous solid network, and due to such a structure they are ultralight-weight. The resulting aerogel in addition to low density has thermally insulating properties, i.e., low thermal conductivity. Other methods of manufacture are now used to produce similar products.

An aerogel may be based on inorganic or organic materials, e.g., silica, magnesia, titania, zirconia, alumina, chromia, tin dioxide, lithium dioxide, ceria and vanadium pentoxide, and combination of any two or more thereof, and organic carbon containing polymers (carbon aerogels) or resorcinol-formaldehyde or melamine-formaldehyde aerogel particles. Suitable hydrophobic aerogel particles are commercially available, and methods for preparing suitable hydrophobic aerogels are known (see, e.g., PCT Patent Application Publications WO 99/36355A2; WO 99/36356A2; WO 99/36479A1; WO 98/45210A2; WO 98/45035A1; WO 98/45032A1; WO 96/18456A2 and U.S. Patent Application Publication 2021/0032499).

The amount and type of G) the insulative filler typically correlates to thermal conductivity, and the insulative filler selection may directly impact corrosion resistance. The nano-porous (90-95%) structure silica aerogel included has a methylated (hydrophobic) surface treatment and is >90% air (740 m²/g surface). In the present thermal insulation coating composition, the hydrophobic aerogel insulative filler specifications may include: pore size 20-60 nm, alternatively 20 nm; particle size 0.1-0.7 mm; and density 0.12-0.15 g/cm³. A suitable silica aerogel has CAS#102262-30-6. Alternatively, the hydrophobic aerogel may have a particle size of 2 micrometers to 1.2 mm. Suitable hydrophobic aerogels are commercially available, such as ENOVA™ IC-3100, ENOVA™ IC-3110 and ENOVA™ IC-3120 from Cabot Corporation of Alpharetta, Georgia, USA.

Alternatively, hollow, non-porous insulative fillers may be used in addition to, or instead of the hydrophobic aerogel described above, in the present thermal insulation coating composition (and the binder described above). The thermal insulation coating composition described herein composition may comprise hollow, non-porous insulative fillers such as SPHERICEL™ hollow glass microspheres from Potters Industries or 3M™ glass bubbles, which are hollow glass spheres with density 0.125-0.6 g/cc; and median particle size 18-65 micron or polymeric bubbles that may be expandable at different temperatures, such as EXPANCEL™ Microspheres available from Nouryon of Amsterdam, Netherlands. Alternatively, Q-CEL™ hollow inorganic microspheres or EXTENDOSPHERES™ (from Sphere One of Chattanooga, Tennessee, USA) are low density, high strength hollow ceramic cenospheres may be used. Hollow, non-porous insulative fillers, the hydrophobic aerogel, and H) the metal oxide are distinct from one another.

### H) Metal Oxide

The metal oxide may be added to the thermal insulation coating composition to provide barrier properties, provide color (i.e. white), improve corrosion resistance, improve hydrophobicity, improve adhesion, provide temperature resistance, act as an opacifying agent, and/or reflect UV. The metal oxide is exemplified by titanium dioxide, zirconium dioxide, iron oxides (including micaceous iron oxide), zirconium silicates, manganese oxides, and combinations thereof. Alternatively, the metal oxide may comprise titanium dioxide. Suitable metal oxides are known in the art and are commercially available, and are described, for example, as IR opacifiers in U.S. Patent Application Publication 2021/0269359 paragraph [00017].

### I) Flash Rust Inhibitor

Starting material I) is a flash rust inhibitor that may be added to the thermal insulation coating composition to inhibit rust formation when the thermal insulation coating composition, which can be in the form of an aqueous emulsion, is applied to a metal substrate, particularly before the water is removed, as described below. Suitable flash rust inhibitors are known, for

example, from U.S. Patent Application Publication 2021/0380840 A1 paragraph [0031]. The flash rust inhibitor may be selected from zinc phosphate tetrahydrate, zinc orthophosphate, zinc phosphate, aluminum dihydrogen phosphate, polyaniline/zinc/cerium nitrate, zinc tannate, magnesium tannate, zinc phosphate aluminum tripolyphosphate (Zn₃(PO₄) 2@AlH₂P₃O₁₀), aluminum tripolyphosphate (AlH₂P₃O₁₀. 2H₂O), zinc oxide or a combination thereof.

Alternatively, the flash rust inhibitor may comprise sodium nitrite. Sodium nitrite can prevent flash rust in direct-to-metal (DTM) application. Sodium nitrite may be delivered in a carrier. For example, sodium nitrite may be delivered as a dispersion in water, such as 15% NaNO₂ and 85% water.

### J) Water

Starting material J) is water. Water is present in the binder and the thermal insulation coating composition. Water may be incorporated via delivery of starting materials A) and B) which are provided in aqueous emulsions starting materials I) and II), respectively. Alternatively, additional water may be added during the method for making the binder and/or the thermal insulation coating composition in a separate additional step. The water is not generally limited, and is as described above for starting material II).

### K) Rheology Modifier

The rheology modifier may be used to stabilize G) the hydrophobic aerogel insulative filler in the (waterborne) thermal insulation coating composition; e.g., to provide sag resistance, improve stability of dispersed insulative filler, and/or to provide buildability (thick film application). Suitable rheology modifiers may comprise a polyurethane resin, a polyacrylic acid, a copolymer of methacrylic acid and acrylate ester, or a fumed silica. Alternatively, the rheology modifier may comprise a polyurethane resin (in an amount of 17 to 25%, alternatively 17 to 18%, and alternatively 22 to 25%), gluconic acid (in an amount of 0 to 5%, alternatively 3 to 5%), enzymatically modified starch (in an amount of 0 to 5%, alternatively 4 to 5%), and water (in an amount of 75 to 80%, alternatively 78 to 80%, alternatively 75 to 78%). Suitable rheology modifiers are commercially available, such as ACRYSOL™ TT-615 Thickener, ACRYSOL™ ASE-60 Thickener, ACRYSOL™ RM-12W, RM-8W, and RM-995 all from The Dow Chemical Company of Midland, Michigan, USA.

Without wishing to be bound by theory, it is thought that the combination of the surfactant and rheology modifier used herein along with the process (including order of addition) to properly incorporate the hydrophobic aerogel insulative filler provides the ability to stabilize the hydrophobic aerogel insulative filler in water (without a “mix before use” requirement for the thermal insulation coating composition) and enables single-coat thick film application.

### Optional Starting Materials

The thermal insulation coating composition may optionally contain one or more additional starting materials. For example, the thermal insulation coating composition may optionally further comprise a colorant such as calcium carbonate or a (non-metal) oxide, such as a mica (e.g., muscovite or phlogopite).

When selecting starting materials for the thermal insulation coating composition described herein, there may be overlap between types of starting materials because certain starting materials described herein may have more than one function. For example, calcium carbonate may be used as a colorant and/or opacifier. When adding additional starting materials to the composition, the additional starting materials are distinct from one another.

### Thermal Insulation Coating Composition

The thermal insulation coating composition may be prepared by the method described above using the starting materials described above. The thermal insulation coating composition may comprise: 17% to 60% of A) the acrylic polymer, 0.002% to 15% of B) the silicone resin, 0 to 1% of C) the antifoam, 0 to 5% of D) the coalescing solvent, 0 to 2% of E) the pH modifier, 0 to 7% of F) the surfactant, 2 to 20% of G) the hydrophobic aerogel insulative filler, 2.5 to 10% of H) the metal oxide, 0.1 to 1.2% of I) the flash rust inhibitor, 0 to 45% (alternatively >0 to 45%) of J) the water, and 0 to 5% of K) the rheology modifier.

Alternatively, the thermal insulation coating composition may comprise 35% to 45% of A) the acrylic polymer, 2% to 7.3% of B) the silicone resin, 0.002% to 0.003% of C) the antifoam, 0.85% to 2% of D) the coalescing solvent, 1% to 2% of F) the pH modifier, 1.8% to 3% of F) the surfactant, 7.5% to 9.5% of G) the insulative filler, 3% to 5% of H) the metal oxide, 0.7% to 1% of I) the flash rust inhibitor, 35% to 45% of J) the water, and 0.35 to 1.3% of K) the rheology modifier.

### Method of Use of the Composition

The thermal insulation coating composition described above can be applied to a surface of an asset to be insulated by various means. The composition can be spray, brush, or roll applied in a single coat, multiple coats, injected, or poured into a mold and casted to achieve adequate thermal insulation. The asset to be insulated may be, for example, a tank, pipe, vessel, furnace, valve, boiler, oven, liquefied gas container, or cooling unit. The surface of the asset to be insulated may comprise metal, e.g., steel as its material of construction.

A method for insulating an apparatus may comprise: i) applying the thermal insulation coating composition described above in a layer on a surface of the apparatus, and ii) removing water from the thermal insulation coating composition, thereby forming a thermal insulation coating on the surface of the apparatus. The thermal insulation coating composition may be applied in step 1) in an amount sufficient to provide a thermal insulation coating with a thickness up to 390 mils, alternatively up to 390 to 400 mils, in a single coat on a horizontal surface or up to 250 mils, alternatively up to 250 mils to 260 mils on a vertical surface in a single coat. The method may optionally further comprise repeating steps i) and ii) one or more times to increase thickness of the thermal insulation coating. The method may optionally further comprise applying a primer to the surface before step i). However, a primer is not required, and the thermal insulation coating composition may be applied directly to the metal surface to form a thermal insulation coating that adheres to the metal surface and that provides corrosion resistance. The method may optionally further comprise applying a topcoat over the thermal insulation coating prepared as described above. However, a topcoat is not required.

### EXAMPLES

The following examples are provided to illustrate the invention to one skilled in the art and are not to be construed as limiting the scope of the invention set forth in the appended claims. The starting materials used in these examples are summarized in Table 1.

TABLE 1
Starting Materials

| Starting Material | | | |
|---|---|---|---|
| type (Function) | Product Name | Chemical Description | Source |
| First Aqueous | RHOPLEX ™ EC- | aqueous emulsion of an acrylic | Dow |
| Emulsion I-1) | 1791 | polymer with a modulus of 20 | |
| Binder | | psi | |
| First Aqueous | RHOPLEX ™ 2019RX | aqueous emulsion of an acrylic | Dow |
| Emulsion I-2) | | polymer with a modulus of 40 | |
| Binder | | psi | |
| Comparative Binder | MAINCOTE ™ PR-71 | aqueous emulsion of an acrylic | Dow |
| | | polymer with a modulus of | |
| | | 13,835 psi | |
| Comparative Binder | MAINCOTE ™ 5045 | aqueous emulsion of an acrylic | Dow |
| | | polymer with a modulus ≥5,000 | |
| | | psi | |
| Second Aqueous | DOWSIL ™ IE-6694 | described above | Dow |
| Emulsion II-1) | | | |
| Second Aqueous | DOWSIL ™ IE-6683 | described above | Dow |
| Emulsion II-2) | | | |
| Second Aqueous | DOWSIL ™ 901H | described above | Dow |
| Emulsion II-3) | Additive | | |
| Comparative Binder | FORMASHIELD ™ 12 | aqueous emulsion containing an | Dow |
| | Emulsion | acrylic polymer with a modulus | |
| | | of 67 psi | |
| Comparative Binder | RHOPLEX ™ EI-2000 | aqueous emulsion containing an | Dow |
| | Emulsion Polymer | acrylic polymer with a modulus | |
| | | of 297 psi | |
| First Aqueous | RHOPLEX ™ EC- | aqueous emulsion containing an | Dow |
| Emulsion I-3) | 3814 Emulsion | acrylic polymer with a modulus | |
| | Polymer | of 17 psi | |
| Comparative Binder | MAINCOTE ™ IC- | aqueous emulsion containing an | Dow |
| | 1001 | acrylic polymer with a modulus | |
| | | of 205 psi | |
| Comparative Binder | MAINCOTE ™ IC- | aqueous emulsion containing an | Dow |
| | 1002 | acrylic polymer with a modulus | |
| | | of 79 psi | |
| Comparative Binder | ELASTENE ™ EC- | aqueous emulsion containing an | Dow |
| | 2949 | acrylic polymer with a modulus | |
| | | of 76 psi | |
| Comparative Binder | ELASTENE ™ 300 | aqueous emulsion containing an | Dow |
| | | acrylic polymer with a modulus | |
| | | of 5873 psi | |
| Comparative Binder | RHOPLEX ™ 2438 C | aqueous emulsion containing an | Dow |
| | | acrylic polymer with a modulus | |
| | | of 66 psi | |
| Comparative | DOWSIL ™ IE-6696 | Comparative silicone emulsion | Dow |
| silicone emulsion | | that does not contain silicone | |
| | | resin | |
| First Aqueous | RHOPLEX ™ 4400 | aqueous emulsion containing an | Dow |
| Emulsion | | acrylic polymer with a modulus | |
| | | of 6 psi | |
| Hydrophobic | ENOVA ™ IC-3110 | Nano-porous aerogel | Cabot |
| Insulative Filler | | | |
| Filler | Ti-Pure ™ R-741 | Titanium dioxide (64.5% wt | Chemours |
| | | dispersion in water) | |
| Flash Rust Inhibitor | Sodium nitrite | Sodium nitrite | Sigma |
| | | | Aldrich |
| | | | or other |
| Antifoam | DOWSIL ™ 8590 | described above | Dow |
| | Additive | | |
| Coalescing solvent | UCAR ™ Filmer IBT | Isobutyric acid, monoester with | Dow |
| | | 2,2,4-trimethylpentan-1,3-diol | |
| Surfactant/dispersant | PLURONIC ™ P84 | Methyl-oxirane polymer with | BASF |
| | | oxirane | |
| Rheology modifier | ACRYSOL ™ RM- | described above | Dow |
| | 12W Rheology | | |
| | Modifier | | |
| Rheology modifier | ACRYSOL ™ RM-8W | described above | Dow |
| | Rheology Modifier | | |
| Rheology modifier | ACRYSOL ™ TT-615 | described above | Dow |
| | Thickener | | |
| Water | deionized water | H₂O | Deionized |
| | | | Tap |
| pH Modifier | Ammonium hydroxide | Ammonium hydroxide | Ricca or |
| | | | other |

In this Comparative Example 1, RHOPLEX™ EI-2000 (350 g: 80.46 wt %) and UCAR™ Filmer IBT (5.25 g: 1.21 wt %) were combined and stir with a propeller blade on a Lightning II mixer at 250 rpm. Next, DOWSIL™ 8590 Additive (1.05 g: 0.24 wt %) was loaded into the container, and the contents continued to stir with a propeller blade on the Lightning II mixer at 250 rpm until the resulting mixture was uniform. Next Ti Pure™ R-741 Titanium Dioxide Slurry (31.01 g: 7.13 wt %) was added, and then 15 wt % Sodium Nitrite solution in water (3.84 g: 0.88 wt %) was added, and mixing continued. A solution of 25 wt % PLURONIC™ P84 in water (5.46 g: 1.25 wt %) was added. The container was covered, and mixing continued at 250 rpm for 40 minutes until the binder blend was uniform. Mixing speed was then increased to 400 rpm.

Next, ENOVA™ IC-3110 Aerogel (35.56 g: 8.18 wt %) was added portion wise slowly, increasing the rpm to 800 as needed to maintain a vortex in the binder blend. ACRYSOL™ RM 12W Rheology Modifier (1.88 g: 0.43 wt %) was added dropwise, and ACRYSOL™ RM-8W Rheology Modifier (0.94 g: 0.22 wt %) was added dropwise, then the contents of the container were mixed for 10 minutes at 800 rpm.

In this Working Example 2, RHOPLEX™ EC-3814 (350.00 g; 75.57 wt %) and DOWSIL™ 6694 (28.00 g; 6.05 wt %) were added to a container and stirred with a propeller blade on a Lightning II mixer at 250 rpm. DOWSIL™ 8590 Additive (1.13 g: 0.25 wt %) was added. Ammonium hydroxide (3.67 g; 0.79 wt %) was added. The container contents were stirred with a propeller blade on a Lightning II mixer at 250 rpm until the mixture was uniform (40 min in this example). Next, UCAR™ Filmer IBT (5.25 g: 1.13 wt %) was added, and the resulting mixture was stirred with a propeller blade on a Lightning II mixer at 250 rpm.

Next, Ti Pure™ R-741 Titanium Dioxide Slurry (33.49 g: 7.23 wt %) was loaded into the container, and then 15 wt % Sodium Nitrite solution in water (4.32 g: 0.93 wt %) was loaded, and mixing continued. A solution of 25 wt % PLURONIC™ P84 in water (5.46 g: 1.18 wt %) was added, the container was covered, and mixing continued at 250 rpm for 40 minutes until the binder blend was uniform. Mixing speed was increased to 400 rpm. Next, ENOVA™ IC-3110 Aerogel (29.00 g: 6.26 wt %) was added portion wise slowly, increasing the rpm to 800 as needed to maintain a vortex in the binder blend. Next, ACRYSOL™ RM-12W Rheology Modifier (1.88 g: 0.41 wt %) was added dropwise, and ACRYSOL™ RM-8W Rheology Modifier (0.94 g: 0.20 wt %) was added dropwise, then the resulting mixture was mixed for 10 minutes at 800 rpm.

In this Comparative Example 3 FORMASHIELD™ 12 Emulsion (325.00 g; 70.92 wt %) and DOWSIL™ IE-6683 (64.15 g; 14.00 wt %) were loaded to a container and stirred with a propeller blade on a Lightning II mixer at 250 rpm. DOWSIL™ 8590 Additive (1.17 g: 0.25 wt %) was added to the container. Stirring continued with a propeller blade on a Lightning II mixer at 250 rpm until the mixture was uniform (40 min in this example). UCAR™ Filmer IBT (4.87 g: 1.06 wt %) was added, and the mixture was stirred with a propeller blade on a Lightning II mixer at 250 rpm.

Next, Ti Pure™0 R-741 Titanium Dioxide Slurry (27.58 g: 6.02wt %) and 15 wt % Sodium Nitrite solution in water (4.29 g: 0.94 wt %) were added, and mixing continued. A solution of 25 wt % PLURONIC™ P84 in water (5.07 g: 1.11 wt %) was added, and the container was covered. Mixing continued at 250 rpm for 40 minutes until the binder blend was uniform. Mixing speed was increased to 400 rpm.

ENOVA™ IC-3110 Aerogel (23.50 g: 5.13 wt %) was added portion wise slowly, increasing the rpm to 800 as needed to maintain a vortex in the binder blend. ACRYSOL™ RM-12W Rheology Modifier (1.75 g: 0.38 wt %) was added dropwise, and ACRYSOL™ RM-8W Rheology Modifier (0.87 g: 0.19 wt %) was added dropwise. The resulting mixture was mixed for 10 minutes at 800 rpm.

In this Working Example 4, RHOPLEX™ EC-1791 (300.00 g; 53.96 wt %) and DOWSIL™ IE-6683 (67.20 g; 12.10 wt %) and De-ionized water (116.09 g: 20.88 wt %) were added to a container and stirred with a propeller blade on a Lightning II mixer at 250 rpm. DOWSIL™ 8590 Additive (1.10 g: 0.20 wt %) was added. The container contents were stirred with a propeller blade on a Lightning II mixer at 250 rpm until the mixture was uniform (40 min in this example).

Next, Ti Pure™ R-741 Titanium Dioxide Slurry (26.58 g: 4.78 wt %) was loaded into the container, and then 15 wt % Sodium Nitrite solution in water (5.26 g: 0.95 wt %) was loaded, and mixing continued. A solution of 25 wt % PLURONIC™ P84 in water (4.69 g: 0.84 wt %) was added, the container was covered, and mixing continued at 250 rpm for 40 minutes until the binder blend was uniform. Mixing speed was increased to 400 rpm. Next, ENOVA™ IC-3110 Aerogel (30.49 g: 5.48 wt %) was added portion wise slowly, increasing the rpm to 800 as needed to maintain a vortex in the binder blend, then the resulting mixture was mixed for 10 minutes at 800 rpm. ACRYSOL™ TT-615 Thickener (4.53 g: 0.81 wt %) was added dropwise. The resulting mixture was mixed for 10 minutes at 800 rpm.

In Working Example 5, RHOPLEX™ EC-3814 (20.00 g; 60.42 wt %) and DOWSIL™ 6683 (4.92 g; 14.88 wt %) were added to a container and stirred with a propeller blade on a Lightning II mixer at 250 rpm. DOWSIL™ 8590 Additive (0.06 g: 0.18 wt %) was added. Ammonium hydroxide (0.4 g; 1.21 wt %) was added. The container contents were stirred with a propeller blade on a Lightning II mixer at 250 rpm until the mixture was uniform (40 min in this example). Next, UCAR™ Filmer IBT (0.30 g: 0.91 wt %) was added, and the resulting mixture was stirred with a propeller blade on a Lightning II mixer at 250 rpm.

Next, Ti Pure™ R-741 Titanium Dioxide Slurry (1.77 g: 5.35 wt %) was loaded into the container, and then 15 wt % Sodium Nitrite solution in water (0.69 g: 2.09 wt %) was loaded and mixing continued. A solution of 25 wt % PLURONIC™ P84 in water (1.04 g: 3.15 wt %) was added, the container was covered, and mixing continued at 250 rpm for 40 minutes until the binder blend was uniform. Mixing speed was increased to 400 rpm. Next, ENOVA™ IC-3110 Aerogel (3.50 g: 10.57 wt %) was added portion wise slowly, increasing the rpm to 800 as needed to maintain a vortex in the binder blend. Next, ACRYSOL™ RM-12W Rheology Modifier (0.21 g: 0.62 wt %) was added dropwise, and ACRYSOL™ RM-8W Rheology Modifier (0.21 g: 0.62 wt %) was added dropwise, then the resulting mixture was mixed for 10 minutes at 800 rpm.

In Working Example 6, RHOPLEX™ EC-1791 (50.00 g; 71.44 wt %) and DOWSIL™ 6694 (3.40 g; 4.86 wt %) were added to a container and stirred with a propeller blade on a Lightning II mixer at 250 rpm. DOWSIL™ 8590 Additive (0.15 g: 0.21 wt %) was added. The container contents were stirred with a propeller blade on a Lightning II mixer at 250 rpm until the mixture was uniform (40 min in this example). Next, UCAR™ Filmer IBT (0.75 g: 1.07 wt %) was added, and the resulting mixture was stirred with a propeller blade on a Lightning II mixer at 250 rpm.

Next, Ti Pure™ R-741 Titanium Dioxide Slurry (4.43 g: 6.33 wt %) was loaded into the container, and then 15 wt % Sodium Nitrite solution in water (1.37 g: 1.96 wt %) was loaded and mixing continued. A solution of 25 wt % PLURONIC™ P84 in water (1.93 g: 2.75 wt %) was added, the container was covered, and mixing continued at 250 rpm for 40 minutes until the binder blend was uniform. Mixing speed was increased to 400 rpm. Next, ENOVA™ IC-3110 Aerogel (7.20 g: 10.29 wt %) was added portion wise slowly, increasing the rpm to 800 as needed to maintain a vortex in the binder blend. Next, ACRYSOL™ RM-12W Rheology Modifier (0.38 g: 0.54 wt %) was added dropwise, and ACRYSOL™ RM-8W Rheology Modifier (0.38 g: 0.54 wt %) was added dropwise, then the resulting mixture was mixed for 10 minutes at 800 rpm.

In Working Example 7, RHOPLEX™ 2019RX (40.00 g; 63.64 wt %) and DOWSIL™ 6683 (8.90 g; 14.16 wt %) were added to a container and stirred with a propeller blade on a Lightning II mixer at 250 rpm. DOWSIL™ 8590 Additive (0.12 g: 0.19 wt %) was added. The container contents were stirred with a propeller blade on a Lightning II mixer at 250 rpm until the mixture was uniform (40 min in this example). Next, UCAR™ Filmer IBT (0.60 g: 0.95 wt %) was added, and the resulting mixture was stirred with a propeller blade on a Lightning II mixer at 250 rpm.

Next, Ti Pure™ R-741 Titanium Dioxide Slurry (3.54 g: 5.64 wt %) was loaded into the container, and then 15 wt % Sodium Nitrite solution in water (1.18 g: 1.87 wt %) was loaded and mixing continued. A solution of 25 wt % PLURONIC™ P84 in water (1.66 g: 2.64 wt %) was added, the container was covered, and mixing continued at 250 rpm for 40 minutes until the binder blend was uniform. Mixing speed was increased to 400 rpm. Next, ENOVA™ IC-3110 Aerogel (6.20 g: 9.86 wt %) was added portion wise slowly, increasing the rpm to 800 as needed to maintain a vortex in the binder blend. Next, ACRYSOL™ RM-12W Rheology Modifier (0.33 g: 0.52 wt %) was added dropwise, and ACRYSOL™ RM-8W Rheology Modifier (0.33 g: 0.52 wt %) was added dropwise, then the resulting mixture was mixed for 10 minutes at 800 rpm. In Working Example 8, RHOPLEX™ 2019RX (40.00 g; 63.64 wt %) and DOWSIL™ 6694 (2.75 g; 4.89 wt %) were added to a container and stirred with a propeller blade on a Lightning II mixer at 250 rpm. DOWSIL™ 8590 Additive (0.12 g: 0.21 wt %) was added. The container contents were stirred with a propeller blade on a Lightning II mixer at 250 rpm until the mixture was uniform (40 min in this example). Next, UCAR™ Filmer IBT (0.60 g: 1.07 wt %) was added, and the resulting mixture was stirred with a propeller blade on a Lightning II mixer at 250 rpm.

Next, Ti Pure™ R-741 Titanium Dioxide Slurry (3.54 g: 6.30 wt %) was loaded into the container, and then 15 wt % Sodium Nitrite solution in water (1.15 g: 2.05 wt %) was loaded and mixing continued. A solution of 25 wt % PLURONIC™ P84 in water (1.60 g: 2.80 wt %) was added, the container was covered, and mixing continued at 250 rpm for 40 minutes until the binder blend was uniform. Mixing speed was increased to 400 rpm. Next, ENOVA™ IC-3110 Aerogel (5.90 g: 10.49 wt %) was added portion wise slowly, increasing the rpm to 800 as needed to maintain a vortex in the binder blend. Next, ACRYSOL™ RM-12W Rheology Modifier (0.55 g: 0.26 wt %) was added dropwise, and ACRYSOL™ RM-8W Rheology Modifier (0.55 g: 0.26 wt %) was added dropwise, then the resulting mixture was mixed for 10 minutes at 800 rpm.

In Comparative Example 9 FORMASHIELD™ 12 Emulsion (40.00 g; 73.49 wt %) and DOWSIL™ IE-6694 (2.44 g; 4.48 wt %) were loaded to a container and stirred with a propeller blade on a Lightning II mixer at 250 rpm. DOWSIL™ 8590 Additive (0.12 g: 0.22 wt %) was added to the container. Stirring continued with a propeller blade on a Lightning II mixer at 250 rpm until the mixture was uniform (40 min in this example). UCAR™ Filmer IBT (0.60 g: 1.10 wt %) was added, and the mixture was stirred with a propeller blade on a Lightning II mixer at 250 rpm.

Next, Ti Pure™ R-741 Titanium Dioxide Slurry (3.54 g: 6.51 wt %) and 15 wt % Sodium Nitrite solution in water (0.86 g: 1.58 wt %) were added and mixing continued. A solution of 25 wt % PLURONIC™ P84 in water (1.34 g: 2.46 wt %) was added, and the container was covered. Mixing continued at 250 rpm for 40 minutes until the binder blend was uniform. Mixing speed was increased to 400 rpm.

ENOVA™ IC-3110 Aerogel (5.00 g: 9.19 wt %) was added portion wise slowly, increasing the rpm to 800 as needed to maintain a vortex in the binder blend. ACRYSOL™ RM-12W Rheology Modifier (0.26 g: 0.49 wt %) was added dropwise, and ACRYSOL™ RM-8W Rheology Modifier (0.26 g: 0.49 wt %) was added dropwise. The resulting mixture was mixed for 10 minutes at 800 rpm.

In Comparative Example 10 MAINCOTE™ 5045 Emulsion (40.00 g; 74.28 wt %) and DOWSIL™ IE-6694 (2.29 g; 4.25 wt %) were loaded to a container and stirred with a propeller blade on a Lightning II mixer at 250 rpm. DOWSIL™ 8590 Additive (0.12 g: 0.22 wt %) was added to the container. Stirring continued with a propeller blade on a Lightning II mixer at 250 rpm until the mixture was uniform (40 min in this example). UCAR™ Filmer IBT (0.60 g: 1.11 wt %) was added, and the mixture was stirred with a propeller blade on a Lightning II mixer at 250 rpm.

Next, Ti Pure™ R-741 Titanium Dioxide Slurry (3.54 g: 6.58 wt %) and 15 wt % Sodium Nitrite solution in water (0.84 g: 1.56 wt %) were added and mixing continued. A solution of 25 wt % PLURONIC™ P84 in water (1.26 g: 2.33 wt %) was added, and the container was covered. Mixing continued at 250 rpm for 40 minutes until the binder blend was uniform. Mixing speed was increased to 400 rpm.

ENOVA™ IC-3110 Aerogel (4.70 g: 8.73 wt %) was added portion wise slowly, increasing the rpm to 800 as needed to maintain a vortex in the binder blend. ACRYSOL™ RM-12W Rheology Modifier (0.25 g: 0.46 wt %) was added dropwise, and ACRYSOL™ RM-8W Rheology Modifier (0.25 g: 0.46 wt %) was added dropwise. The resulting mixture was mixed for 10 minutes at 800 rpm.

In Comparative Example 11 MAINCOTE™ PR-71 Emulsion (40.00 g; 69.30 wt %) and DOWSIL™ 6696 (5.11 g; 8.85 wt %) were loaded to a container and stirred with a propeller blade on a Lightning II mixer at 250 rpm. DOWSIL™ 8590 Additive (0.12 g: 0.21 wt %) was added to the container. Stirring continued with a propeller blade on a Lightning II mixer at 250 rpm until the mixture was uniform (40 min in this example). UCAR™ Filmer IBT (0.60 g: 1.04 wt %) was added, and the mixture was stirred with a propeller blade on a Lightning II mixer at 250 rpm.

Next, Ti Pure™ R-741 Titanium Dioxide Slurry (3.54 g: 6.14 wt %) and 15 wt % Sodium Nitrite solution in water (0.93 g: 1.61 wt %) were added and mixing continued. A solution of 25 wt % PLURONIC™ P84 in water (1.44 g: 2.50 wt %) was added, and the container was covered. Mixing continued at 250 rpm for 40 minutes until the binder blend was uniform. Mixing speed was increased to 400 rpm.

ENOVA™ IC-3110 Aerogel (5.40 g: 9.36 wt %) was added portion wise slowly, increasing the rpm to 800 as needed to maintain a vortex in the binder blend. ACRYSOL™ RM-12W Rheology Modifier (0.29 g: 0.49 wt %) was added dropwise, and ACRYSOL™ RM-8W Rheology Modifier (0.29 g: 0.49 wt %) was added dropwise. The resulting mixture was mixed for 10 minutes at 800 rpm.

Corrosion rating and was evaluated according to the test method below. Cracking after drying was evaluated by visual inspection. Results are shown below in Table 2.

TABLE 2
Corrosion and Cracking Ratings

| | | | Coating |
|---|---|---|---|
| | | Corrosion | Cracked? |
| Binder Combination | Sample | rating | Yes/No |
| RHOPLEX ™ EI-2000, acrylic polymer | Comparative | 0 | Yes |
| with modulus 297 No silicone | example 1 | | |
| RHOPLEX ™ EC-3814, acrylic polymer | Working | 4 | No |
| with modulus 17 + | example 2 | | |
| DOWSIL ™ 6694 | | | |
| I-2) RHOPLEX ™ EC-3814, acrylic | Working | 6 | No |
| polymer with modulus 17 + II-2) | example 5 | | |
| DOWSIL ™ IE-6683 | | | |
| FORMASHIELD ™ 12 Emulsion, acrylic | Comparative | 3 | No |
| polymer with modulus 67 | example 3 | | |
| II-2) DOWSIL ™ IE-6683 | | | |
| I-2) RHOPLEX ™ EC-1791, acrylic | Working | 4 | No |
| polymer with modulus 20 | example 4 | | |
| II-2) DOWSIL ™ IE-6683 | | | |
| I-2) RHOPLEX ™ EC-1791, acrylic | Working | 6 | No |
| polymer with modulus 20 | example 6 | | |
| II-2) DOWSIL ™ IE-6694 | | | |
| I-2) RHOPLEX ™ 2019RX acrylic | Working | 6 | No |
| polymer with modulus 40 | example 7 | | |
| II-2) DOWSIL ™ IE-6683 | | | |
| I-2) RHOPLEX ™ 2019RX acrylic | Working | 7 | No |
| polymer with modulus 40 | example 8 | | |
| II-2) DOWSIL ™ IE-6694 | | | |
| FORMASHIELD ™ 12 Emulsion, acrylic | Comparative | 3 | No |
| polymer with modulus 67 II-2) IE-6694 | example 9 | | |
| I-2) MAINCOTE ™ 5045 Emulsion, | Comparative | 2 | Yes |
| acrylic polymer with a modulus ≥5,000 psi | example 10 | | |
| II-2) DOWSIL ™ IE-6694 | | | |
| I-2) MAINCOTE ™ PR-71 Emulsion, | Comparative | 0 | Yes |
| acrylic polymer with a modulus 13835 psi | example 11 | | |
| II-2) DOWSIL ™ IE-6696 | | | |

In Table 2, a higher number indicates better corrosion rating, i.e., less corroded sample, and 0 indicates worst corrosion rating (most corroded sample). Working examples 2 and 4 exhibited good corrosion resistance, with value≥4. In contrast Comparative Examples 1 and 3 each exhibited poor corrosion resistance, as evidenced by the corrosion resistance values of 2 and 3. Working examples 2 and 3 in Table 2 show that the coatings including the combination of an acrylic polymer with Young's modulus<50 psi and a silicone resin had both good corrosion resistance and did not crack under the conditions tested. Comparative example 3 showed that when Young's modulus of the acrylic polymer was 67 psi, corrosion rating was not as good as in Working Example 4, even though the same silicone resin was used.

In this Reference Example I: Samples of thermal insulation coating compositions were prepared as follows: First, a mixture was prepared by loading an acrylic binder, shown below in Table 3 (300.00 g; 46.6 wt %) to a container and stirring with a propeller blade on a Lightning II mixer at 250 rpm. Next, DOWSIL™ 8590 Additive (1.50 g: 0.2 wt %) was loaded into the container, and the contents continued to stir with a propeller blade on the Lightning II mixer at 250 rpm until the resulting mixture was uniform (40 min in this example).

Next, a thermal insulation coating was prepared as follows: 501.50 g of the mixture prepared as described above (77.8 wt %) and UCAR™ Filmer IBT (7.50 g: 1.2 wt %) were combined and stirred with a propeller blade on a Lightning II mixer at 250 rpm. Next, Ti Pure™ R-741 Titanium Dioxide Slurry (44.30 g: 6.9 wt %) was added, and then 15 wt % Sodium Nitrite solution in water (5.68 g: 0.1 wt %) was added, and mixing continued. A solution of 25 wt % PLURONIC™ P84 in water (7.80 g: 1.2 wt %) was added, the container was covered, and mixing continued at 250 rpm for 40 minutes until the mixture was uniform. Mixing speed was increased to 400 rpm. ENOVA™ IC-3110 Aerogel (56.54 g: 8.8 wt %) was added portion wise slowly, increasing the rpm to 800 as needed to maintain a vortex in the mixture. ACRYSOL™ RM-12W Rheology Modifier (2.69 g: 0.4 wt %) was added dropwise, and ACRYSOL™ RM-8W Rheology Modifier (1.34 g: 0.2 wt %) was added dropwise, then the mixture was mixed for 10 minutes at 800 rpm.

The samples were evaluated for corrosion according to the test method described below and visually inspected for cracking after drying. The results are in Table 3.

TABLE 3
Additional Comparative Samples without Silicone Resin

| | | Modulus | Corrosion | Coating Cracked? |
|---|---|---|---|---|
| Sample | Acrylic Emulsion | [Psi] | rating | Yes/No |
| Comparative a | MAINCOTE ™ IC-1001 | 205 | 3 | Yes |
| Comparative b | MAINCOTE ™ PR-71 | 13835 | 3 | Yes |
| Comparative c | FORMASHIELD ™ 12 | 67 | 3 | No |
| | Emulsion | | | |
| Comparative d | RHOPLEX ™ EC-3814 | 17 | 3 | No |
| Comparative e | RHOPLEX ™ EI-2000 | 297 | 0 | Yes |
| Comparative f | RHOPLEX ™ EC-1791 | 20 | 3 | No |
| Comparative g | MAINCOTE ™ IC-1002 | 79 | 2 | Yes |
| Comparative h | ELASTENE ™ EC-2949 | 76 | 2 | Yes |
| Comparative i | ELASTENE ™ 300 | 5873 | 2 | Yes |
| Comparative j | RHOPLEX ™ 2438C | 66 | 3 | Yes |
| Comparative k | RHOPLEX ™ 4400 | 6 | 3 | No |
| Comparative l | RHOPLEX ™ 2019RX | 40 | 3 | No |

The data in Table 2 shows that using the combination of an acrylic polymer with a modulus<50 psi in combination with a silicone resin in the composition produces a thermal insulation coating with a good corrosion rating (≥4) without cracking. Working examples 2, 4, 5, 6, 7, and 8 all had good corrosion resistance without cracking. Comparative example 2 and Working examples 4, 5 and 7 showed that when the acrylic polymer had a modulus that was too high (67 psi), the coating prepared from the composition had poor corrosion resistance, however coatings that contained an acrylic polymer with lower modulus (17, 20, or 40 psi in the working examples) had good corrosion resistance without cracking, even when the same silicone resin was used. The data in Table 3 show that when a silicone resin is not used, corrosion rating is poor, i.e., 3 or less. Working examples 2 and 5 in Table 2 and comparative d in Table 3 show that the use of the silicone resin improves corrosion rating when RHOPLEX™ EC-3814 is used under the conditions tested. Working examples 4 and 6 in Table 2 and comparative f in Table 3 show that the use of the silicone resin improves corrosion rating when RHOPLEX™ EC-1791 is used under the conditions tested. Working examples 7 and 8 in Table 2 and comparative 1 in Table 3 show that the use of the silicone resin improves corrosion rating when RHOPLEX™ 2019RX is used under the conditions tested.

### Industrial Applicability

The examples above demonstrate that the binder and thermal insulation coating composition of the present invention provide the unexpected benefit of forming a coating with good corrosion resistance (≥4 corrosion rating) according to the corrosion test method herein without cracking. Furthermore, thermal insulation coatings can be prepared from the silicone-acrylic binder and the thermal insulation coating composition described herein with low thermal conductivity. For example, without wishing to be bound by theory it is thought that a thermal insulation coating with a thermal conductivity of ≥0.045 W/mK. The single coat thickness of the thermal insulation coating may be up to 400 mil on a horizontal surface or up to 250 mil on a vertical surface. Alternatively, the single coat thickness may be 20-400 mil; alternatively 80-400 mil on a horizontal surface. Alternatively, the single coat thickness may be 20-250 mil; alternatively 80-250 mil on a vertical surface.

### Test Methods

The following test methods were used to measure properties herein, unless otherwise indicated. Samples were coated on metal substrates, dried and corroded according to ASTM B-117, except that the time was more than 2000 hours. The corrosion was measured according to ASTM Standard D1654-08 Standard Test Method for Evaluation of Painted or Coated Specimens Subjected to Corrosive Environments.

Modulus Measurements of the acrylic polymers were performed as follows: Films for Young's modulus measurements were prepared by adding 15-20 g of emulsions as received to 2.5″×3″ Teflon molds clamped on top of release liners. The films were dried at room temperature for 7 days. The dried films were cut into a dog-bone shape using a DIN S2 die. Strain-stress curves were collected on an MTS Alliance RT-5 at 20.0 in/min using a 100 N load cell. Young's Modulus was automatically calculated using the instrument software based on the slope at the low-strain section of the strain-stress curve. Measurements were made with 4 dog-bones per material.

Particle Size Measurements were made as follows: A sample was prepared by diluting 0.1 g of an emulsion (corresponding to any of starting materials I) or II) described herein) in 20 mL of water. Particle size was measured using a Mastersizer™ 3000 laser diffraction particle size analyzer from Malvern Instruments. The average particle size expressed as volume-averaged median diameter, Dv50, is used to address the particle size of the first (soft) acrylic polymer and second (hard) acrylic polymer. Particle size ratio may be calculated by Dv50 of the first acrylic polymer divided by Dv50 of the second acrylic polymer.

### Definitions and Usage of Terms

All amounts, ratios, and percentages herein are by weight, unless otherwise indicated by the context of the specification. The articles ‘a’, ‘an’, and ‘the’ each refer to one or more, unless otherwise indicated by the context of specification. The singular includes the plural unless otherwise indicated by the context of the specification. The SUMMARY and ABSTRACT are hereby incorporated by reference. The amounts of all starting materials in a composition total 100%. The transitional phrases “comprising”, “consisting essentially of”, and “consisting of” are used as described in the Manual of Patent Examining Procedure Ninth Edition, Revision 08.2017, Last Revised January 2018 at section §2111.03 I., II., and III. Any feature or aspect of the invention may be used in combination with any other feature or aspect recited herein. The abbreviations used herein have the definitions in Table 5.

TABLE 5
Abbreviations

| Abbreviation | Definitions |
|---|---|
| ° C. | degrees Celsius |
| ≤ | less than or equal to |
| ≥ | greater than or equal to |
| cm | centimeter |
| FTIR | Fourier Transform Infra-Red |
| g | gram |
| GPC | gel permeation chromatography |
| h | hour |
| m | meter |
| Me | methyl |
| mg | milligram |
| min | minute |
| mL | milliliter |
| mm | millimeter |
| Mn | number average molecular weight measured by GPC |
| mol | mole |
| mPa · s | milliPascal second |
| Mw | weight average molecular weight measured by GPC |
| nm | nanometer |
| Ph | phenyl |
| ppm | part per million |
| psi | pounds per square inch |
| RPM or rpm | revolutions per minute |
| RT | room temperature of 25 ± 5° C. |
| sec | second |
| μm | micrometer |
| Vi | vinyl |
| W/mK | Watts per meter Kelvin |

1. A binder comprising:
A) an acrylic polymer with a Young's modulua≤50 psi,
B) a silicone resin,
F) a surfactant,
J) water,
optionally C) an antifoam,
optionally D) a coalescing solvent, and
optionally F) a pH modifier.

2. The binder of claim 1, wherein the acrylic polymer has a modulus of 6 psi to 40 psi.

3. The binder of claim 1, where silicone resin comprises unit formula:
(R^{M}₃SiO_{1/2})ₓ(SiO_{4/2})_{y}X¹_{z}, where each R^{M} is an independently selected monovalent hydrocarbon group; X¹ represents a hydroxyl group or other hydrolyzable substituent; subscripts x and y represent molar amounts of the M units and Q units, respectively, in the molecule, and subscript z represents hydroxyl or hydrolyzable group content; and subscripts x, y and z have average values such that 4>x≥0, y>1, z≥0, a quantity (x+y+z) is sufficient to give the silicone resin a weight average molecular weight of 2,000 g/mol to 15,000 g/mole.

4. The binder of claim 1, where the silicone resin comprises a phenyl silsesquioxane resin comprising unit formula (R^{M}₂SiO_{2/2})ₓ(PhSiO_{3/2})_{y}(R^{M1}₃SiO_{1/2})ₐ(R^{M2}₂SiO_{2/2})_{b}(R^{M3}SiO_{3/2})_{c}(SiO_{4/2})_{d}, where each R^{M} is an independently selected monovalent hydrocarbon group; R^{M1}, R^{M2}, and R^{M3} are each independently selected from an alkyl group of 1 to 8 carbon atoms, an aryl group, an amino group, or a carbinol group; subscripts a, b, c, d, x, and y represent mole fractions, each of subscripts x and y independently has a value of 0.05 to 0.95, each of subscripts a, b, c, and d independently has a value of 0 to 0.6, and a quantity (x+y+a+b+c+d)=1.

5. The composition of claim 1, where the binder comprises:
42 to 57.5 weight parts of A) the acrylic polymer,
3 to 8.5 weight parts of B) the silicone resin,
0.25 to 0.35 weight part of C) the antifoam,
1 to 1.6 weight parts of D) the coalescing solvent,
1.2 to 2 weight parts of E) the pH modifier,
38 to 48.8 weight parts of J) water, and
2 to 3 weight parts of F) the surfactant.

6. A method for preparing the binder of claim 1, wherein the method comprises:
1) homogenizing starting materials comprising:
I) a first aqueous emulsion comprising A) the first acrylic polymer, a first surfactant, and water;
II) a second aqueous emulsion comprising aqueous emulsion comprising
B) the silicone resin, a second surfactant, and water;
optionally 2) during and/or after step 1), adding an additional starting material selected from the group consisting of the antifoam, the coalescing solvent, the pH modifier, and a combination of two or more thereof.

7. A thermal insulation coating composition comprising:
A) an acrylic polymer with a modulua≤50 psi,
B) a silicone resin,
F) a surfactant,
J) water,
C) an antifoam,
G) an insulative filler,
I) a flash rust inhibitor,
optionally H) a metal oxide,
optionally F) a pH modifier,
optionally D) a coalescing solvent, and
optionally K) a rheology modifier.

8. The thermal insulation coating composition of claim 7, where the composition comprises:
35 weight % to 45 weight % of A) the acrylic polymer,
2 weight % to 7.3 weight % of B) the silicone resin,
0.002 to 0.003 weight % of C) the antifoam,
0.85 to 2 weight % of D) the coalescing solvent,
1 to 2 weight % of E) the pH modifier,
1.8 weight % to 3 weight % of F) the surfactant,
7.5 weight % to 9.5 weight % of G) the insulative filler,
3 weight % to 5 weight % of H) the metal oxide,
0.7 weight % to 1 weight % of I) the flash rust inhibitor,
35 weight % to 45 weight % of J) the water, and
0.35 weight % to 1.3 weight % of K) the rheology modifier.

9. The composition of claim 7, where G) the insulative filler comprises a hydrophobic aerogel.

10. A method for making a thermal insulation coating composition, wherein the method comprises:
1) practicing the method of claim 7, thereby preparing the binder,
optionally 2) adding F) a surfactant during and/or after step 1),
3) adding G) an insulative filler to the binder prepared in step 1) or step 2) and homogenizing to prepare a filled intermediate; and
4) adding, to the filled intermediate, a slurry comprising H) a metal oxide, and a solution or slurry comprising I) a flash rust inhibitor before, during, or after any one of steps 1) to 3), and homogenizing,
optionally 5) adding F) a pH modifier in step 1) when I) the first aqueous emulsion has pH<8, II) the second aqueous emulsion has pH<8, or both I) and II) have pH<8;
6) adding C) an antifoam before adding the hydrophobic aerogel insulative filler in step 3.

11. The method of claim 10, further comprising adding an additional starting material selected from the group consisting of an additional antifoam, D) a coalescing solvent, additional water, and a combination thereof.

12. The method of claim 10, further comprising adding a rheology modifier after step 2).

13. The method of claim 10, where G) the insulative filler comprises a hydrophobic aerogel.

14. A method for insulating an apparatus, wherein the method comprises:
optionally putting a primer on a metal surface of an apparatus;
i) applying the thermal insulation coating composition of claim 7 in a layer on the metal surface of the apparatus, and
ii) removing water, thereby forming a thermal insulation coating on the metal surface of the apparatus; and
optionally iii) repeating steps i) and ii) one or more times to increase thickness of the thermal insulation coating.

15. The binder of claim 2, where silicone resin comprises unit formula:
(R^{M}₃SiO_{1/2})ₓ(SiO_{4/2})_{y}X¹_{z}, where each R^{M} is an independently selected monovalent hydrocarbon group; X¹ represents a hydroxyl group or other hydrolyzable substituent; subscripts x and y represent molar amounts of the M units and Q units, respectively, in the molecule, and subscript z represents hydroxyl or hydrolyzable group content; and subscripts x, y and z have average values such that 4>x≥0, y>1, z≥0, a quantity (x+y+z) is sufficient to give the silicone resin a weight average molecular weight of 2,000 g/mol to 15,000 g/mole.
